(19) United States
(12) Patent Application Publication
(10) Pub. No.: US 2026/0365381 A1
(43) Pub. Date: Nov. 19, 2026

(54) Charcuterie Board with Cover

(71) Applicant: Tom Sullivan, Escondido, CA (US)

(72) Inventor: Tom Sullivan, Escondido, CA (US)

(21) Appl. No.: 19/675,446

(22) Filed: May 12, 2026

Related U.S. Application Data
(60) Provisional application No. 63/804,782, filed on May 13, 2025.

(51) Int. Cl. B65D 43/02; A47J 47/08; B65D 1/36

(52) U.S. Cl. CPC B65D 43/0208; A47J 47/08; B65D 1/36; B65D 2543/00194; B65D 2543/00351; B65D 2543/00509; B65D 2543/00537; B65D 2543/00555; B65D 2543/00574; B65D 2543/00842

(57) ABSTRACT

A charcuterie board with a removable cover is disclosed, wherein the board includes opposing first and second surfaces configured for selective use. A latch or coupling mechanism is provided for releasably securing the cover to the board. The coupling mechanism is configured to engage attachment features formed along a perimeter of the board and to secure the cover in multiple orientations, allowing the cover to be attached to either surface of the board independent of orientation. The coupling mechanism may include a compression-fit engagement that applies a retention force, and may further include guiding structures, recessed portions, or protrusions to facilitate alignment and secure attachment. Alternative configurations may include snap-fit, friction-fit, or magnetic coupling mechanisms. The latch mechanism enables consistent and reliable attachment of the cover while allowing easy removal, thereby improving usability, food protection, and transportability.

### TECHNICAL FIELD OF THE INVENTION

The present invention relates to a charcuterie board with a cover. More specifically, the present invention relates to a double-sided charcuterie board having a cover, wherein the board includes opposing surfaces that may be the same or different, and wherein a clasp or latch mechanism is configured to selectively and removably attach the cover to either side of the charcuterie board on which a food item is placed and desired to be covered.

### BACKGROUND OF THE INVENTION

Charcuterie boards have gained significant popularity in recent years, serving as an elegant and functional way to present an assortment of meats, cheeses, fruits, nuts, and other accompaniments. Traditional charcuterie boards are often made from wood, bamboo, slate, or other food-safe materials and are designed to enhance both the aesthetic and practical aspects of food presentation. However, conventional charcuterie boards typically lack integrated covering solutions, leaving food exposed to contaminants, environmental elements, and potential spoilage.

Existing food covers or lids are often designed for single-surface use, restricting their versatility and making it difficult to securely cover food items placed on either side of a reversible board. Additionally, conventional food storage solutions, such as plastic wrap, domed lids, or external food covers, often fail to provide a practical, secure, and aesthetically pleasing way to protect the contents of a charcuterie board while maintaining ease of access and transport.

Accordingly, there is a need for an improved charcuterie board with a cover, wherein the charcuterie board is double-sided, allowing for versatile use on either surface, and the cover can securely attach to either side through a clasp or latch mechanism. This innovative approach enhances the functionality of charcuterie boards by enabling users to conveniently cover and store food without worrying about which side of the board is in use.

The present invention addresses these challenges by providing a double-sided charcuterie board with a cover that can be securely attached to either side, ensuring maximum flexibility, convenience, and protection for food items. This improved design allows users to prepare and serve charcuterie on one surface while easily switching to the other side as needed, all while maintaining the ability to securely latch the cover onto the board for food preservation and transportation.

### SUMMARY OF THE INVENTION

The present invention is directed to a charcuterie board with a cover, wherein the charcuterie board is configured as a double-sided board having opposing surfaces that may be the same or different. The invention provides a cover that is selectively and removably attachable to either side of the charcuterie board through a clasp or latch mechanism.

In one aspect, the invention includes a coupling mechanism configured to engage corresponding attachment features formed along a perimeter of the charcuterie board. The coupling mechanism is designed to secure the cover to the board regardless of which surface of the board is facing upward, thereby providing orientation-independent attachment. This allows a user to place food items on either surface of the board and attach the cover without requiring repositioning or modification of the coupling mechanism.

In another aspect, the clasp or latch mechanism may include a compression-fit engagement that applies a retention force between the cover and the board. The coupling mechanism may further include recessed portions, protrusions, or guiding structures that facilitate alignment and secure engagement. Alternative coupling mechanisms, including snap-fit, friction-fit, or magnetic configurations, may also be employed.

In certain embodiments, one surface of the charcuterie board may include divided sections and a recessed portion configured to receive a bowl, while the opposing surface may be substantially flat. The cover may be transparent, domed, or otherwise configured to accommodate and display food items while providing protection.

Accordingly, the present invention provides a reversible charcuterie board with an improved cover attachment system that enhances versatility, ease of use, food protection, and transportability by enabling secure and reliable attachment of the cover to either side of the board.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a perspective view of the double-sided charcuterie board with an attachable cover, showing the general structure and functionality.

FIG. 2 provides an exploded view of the components of the charcuterie board, including the cover, clasp system, and symmetrical attachment sections.

FIG. 3 illustrates a perspective view of the double-sided charcuterie board with an attachable cover, showing the cover resting on the board and the latch in a partially open position.

FIG. 4 illustrates a perspective view of the double-sided charcuterie board with an attachable cover, showing the cover above the board and the latch in an open position.

FIGS. 5 and 6 show the top-down and bottom-up views of the charcuterie board, which may feature identical or different surface textures.

FIGS. 7, 8, 9, 10 presents a side elevation view of the board with the cover securely attached, emphasizing the compression fit of the clasp.

FIG. 11 illustrates a board surface with divided sections that can hold chips, nuts, or other food items, and a circular center recess designed to accommodate a bowl for sauces, dips, or condiments.

FIGS. 12 and 13 show a flat board surface that is ideal for serving cheeses, meats, and other flat food arrangements.

FIG. 14 illustrates a board surface with divided sections that can hold chips, nuts, or other food items, and a circular center recess designed to accommodate a bowl for sauces, dips, or condiments.

FIGS. 15 and 16 provide a detailed view of the symmetrical attachment sections, illustrating the arrangement of recesses and protrusions that enable the cover to be secured to either side of the board.

FIGS. 17 and 18 illustrate alternative clasp configurations, such as snap-fit locks, magnetic closures, and friction-fit mechanisms.

FIGS. 19, 20, 21, 22, 23, 24, and 25 present detailed views of the clasp mechanism attached to the cover and how it engages the charcuterie board using a compression fit, ensuring that the cover can be securely attached no matter which side of the board is facing up.

The broken lines in the drawings represent portions of the display tree and form no part of the claimed design.

### REFERENCE CHARACTER LIST

100—Charcuterie board (platform)
120—First surface
122—Second surface
130—Divided section(s)
135—Central recess (bowl recess)
140—Peripheral edge
150—Handle
200—Cover
210—Cover body
212—Domed portion
214—Peripheral edge of cover
216—Transparent region
300—Clasp/latch mechanism
310—Recessed portion (attachment region)
312—Recessed portion (attachment region)
320—Engagement arm
322—Internal channel
324—Deformable portion
326—Retention surface
400—Symmetrical attachment section
410—Protrusion (alignment feature)
412—Protrusion (alignment feature)
415—Compression-fit groove
420—Guide surface/alignment ramp

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized, and logical, mechanical, electrical, and other changes may be made without departing from the scope of the present invention.

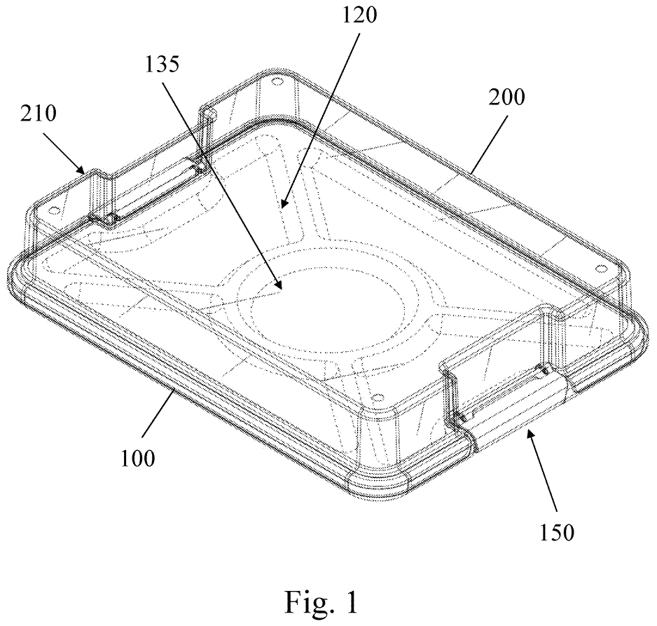

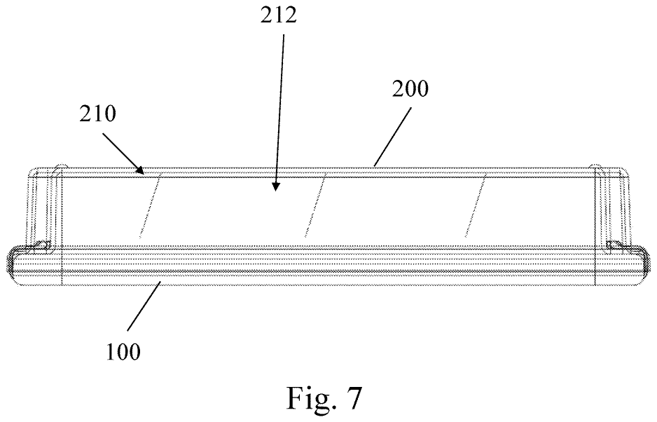

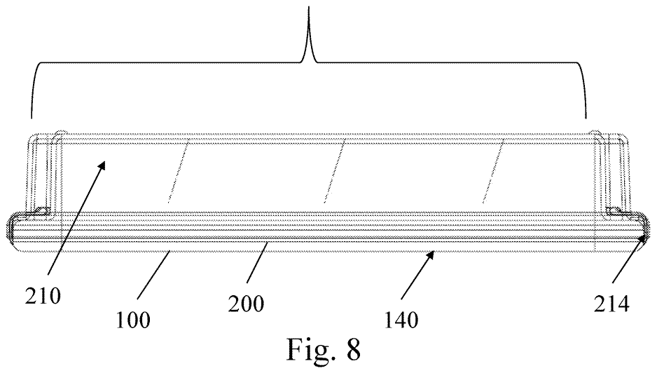

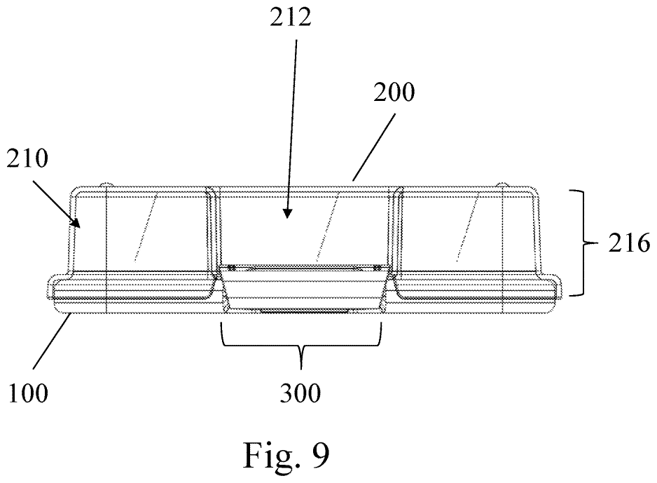

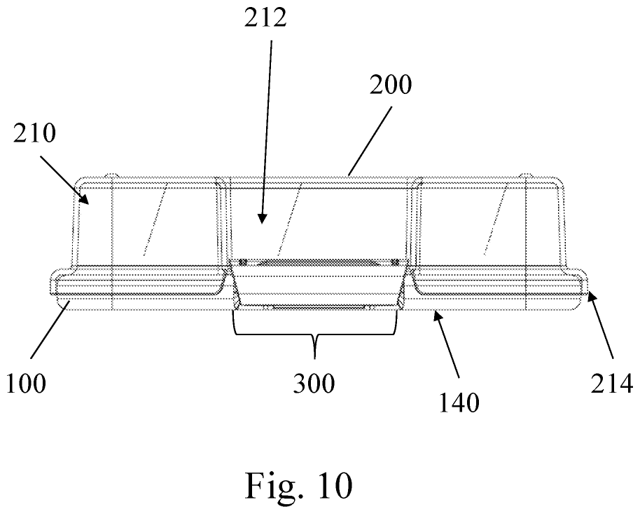

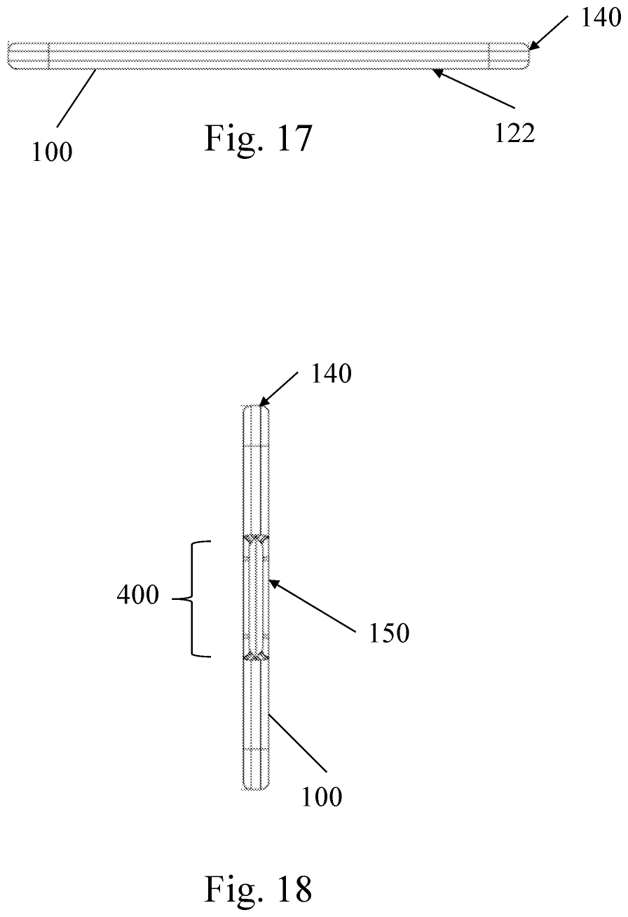

The following detailed description is, therefore, not to be taken in a limiting sense, and the scope of the present invention is defined only by the appended claims. As shown throughout FIG. 1-25, consistent reference numerals are used to identify corresponding structural elements across multiple views and configurations.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention, including the charcuterie board or platform (100), the cover (200), and the clasp or latch mechanism (300), each of which is illustrated in multiple configurations and levels of detail across FIGS. 1-27.

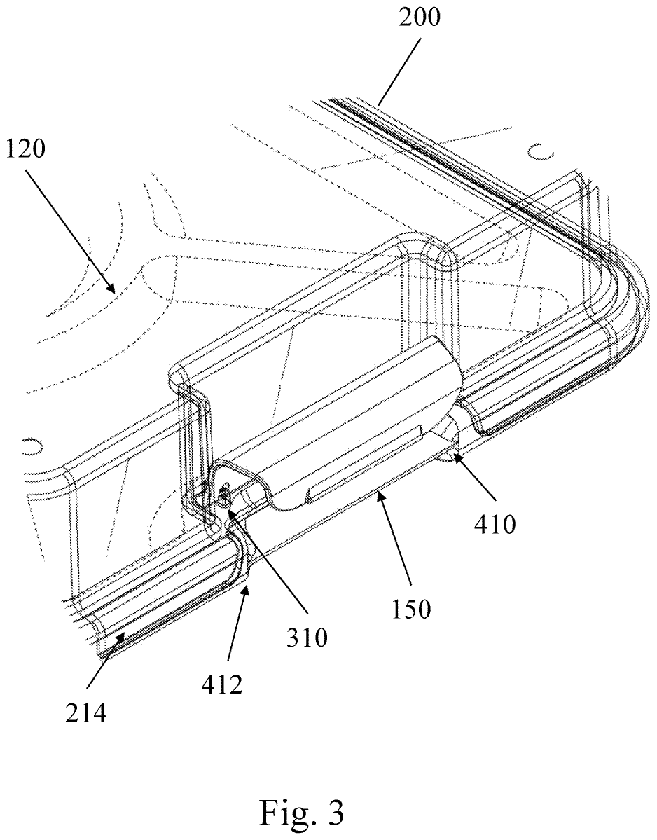

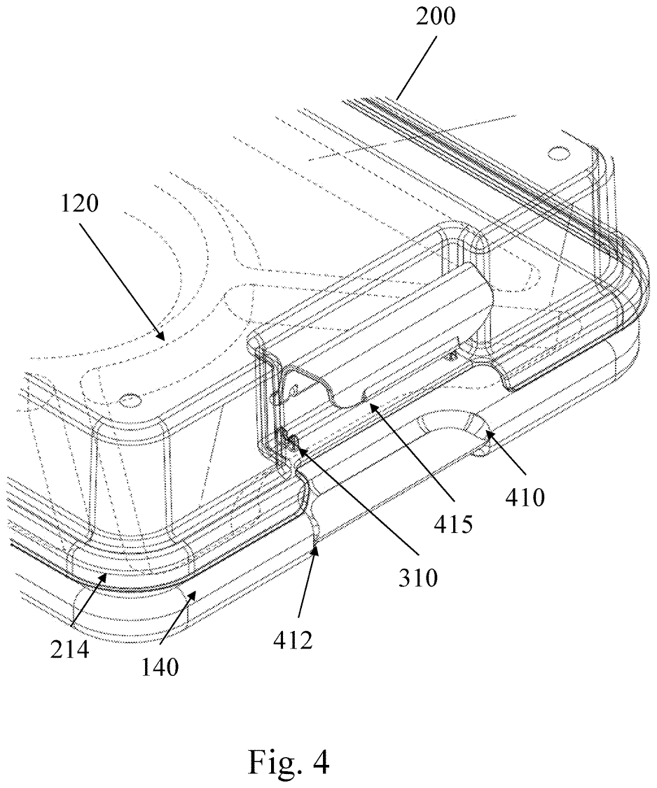

Charcuterie boards are widely used for serving an assortment of meats, cheeses, fruits, and other delicacies in an aesthetically appealing manner. Despite their popularity, conventional charcuterie boards typically lack a secure and integrated food cover, requiring users to resort to plastic wrap or makeshift lids that do not effectively preserve freshness. Furthermore, traditional charcuterie boards are often single-sided, restricting their versatility and requiring users to position the board in a specific orientation to accommodate an optional cover, if available. As illustrated in FIGS. 3 and 4, conventional boards lack the dual-surface capability and corresponding attachment structures shown in the present invention.

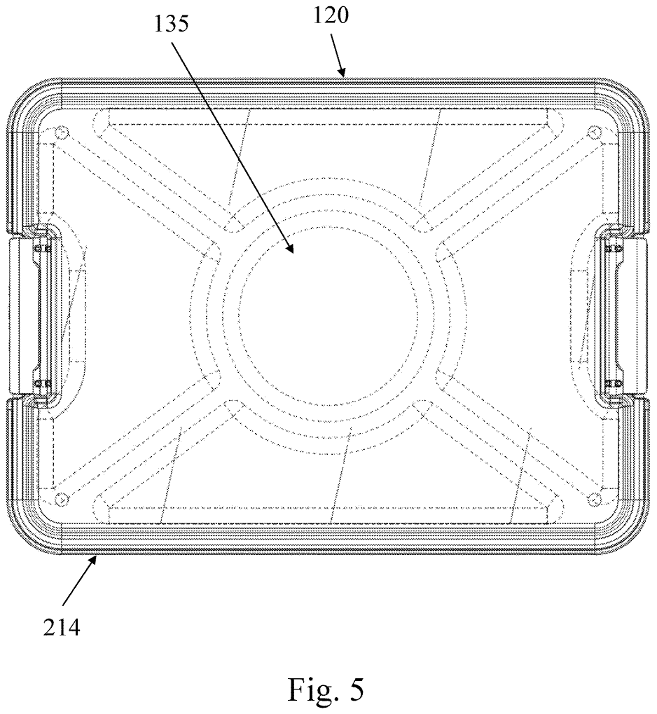

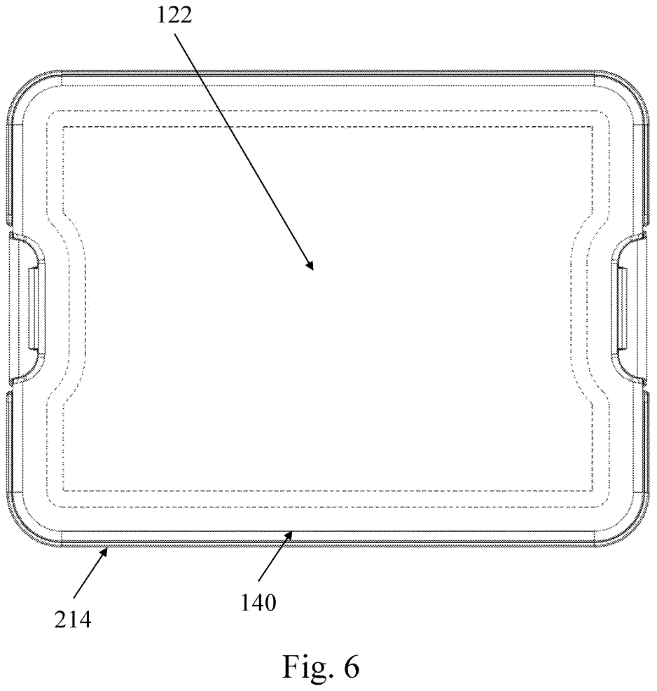

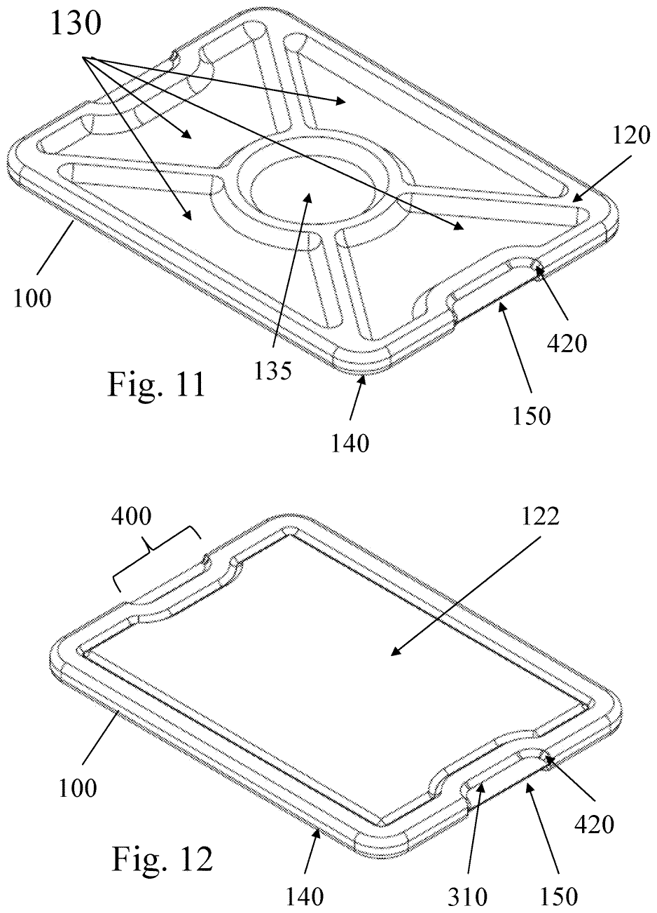

The present invention introduces a double-sided charcuterie board (100) with an attachable cover (200) that can be securely fastened to either surface. A clasp or latch mechanism (300) attached to the cover (200) utilizes a compression fit to engage with the board (100), ensuring a secure and stable attachment regardless of board orientation. This allows the cover (200) to function seamlessly whether either side of the board (100) is facing up or down. As illustrated in FIGS. 5 and 6, the clasp mechanism (300) engages the peripheral edge (140) of the board (100) to maintain attachment. The charcuterie board (100) may feature differing surfaces on each side, providing users with multiple presentation and serving options, as shown in FIGS. 11-14.

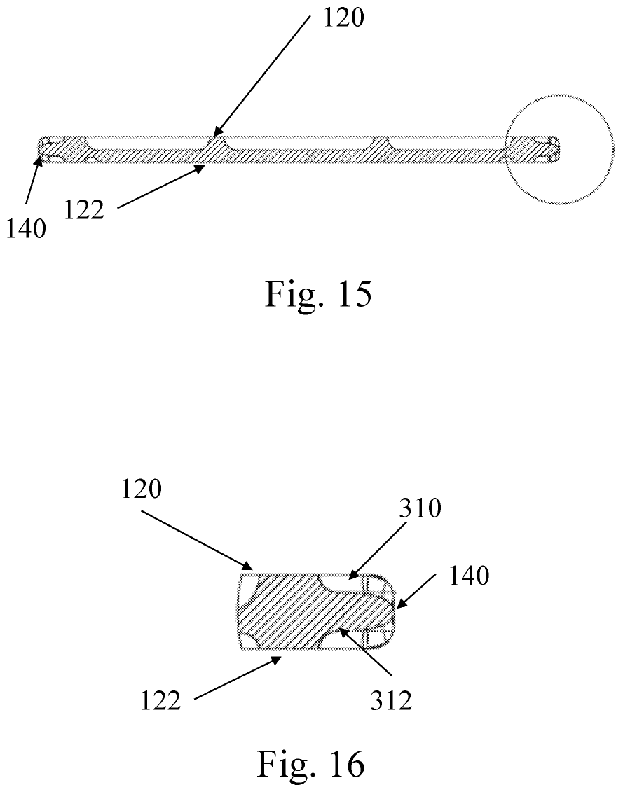

The present invention teaches a double-sided charcuterie board (100) with a universally attachable cover (200), featuring: a compression-fit clasp system (300) that securely attaches the cover (200) to either side of the board (100); differing board surfaces (120, 122) (FIG. 11-14), allowing for versatile food presentation; and a symmetrical attachment system (400) (FIG. 15-16, 19-25), ensuring seamless usability regardless of board orientation. The symmetrical attachment system (400) includes multiple engagement points distributed along the board perimeter, as illustrated in FIGS. 15 and 23-25. The present invention is novel and non-obvious over the prior art by improving food preservation, transportability, and usability.

Now referring to Figures, the double-sided charcuterie board (100) with cover (200) and clasp mechanism (300) is illustrated. The charcuterie board (100) includes a first surface (120) and a second surface (122), allowing users to serve food on either side. The board (100) may be constructed from wood, bamboo, composite materials, or food-grade plastics. It may feature identical or differing surface textures, depending on user preference. The board (100) further includes a peripheral edge (140) extending continuously around its perimeter, which serves as the primary engagement region for the clasp mechanism (300). In certain embodiments, ergonomic handles (150) may be formed along opposing sides of the board (100), as generally suggested in FIG. 1, to facilitate carrying.

FIG. 1 presents the board (100) and cover (200) in an assembled configuration, illustrating the relative positioning of the cover body (210) over the board (100). The cover (200) includes a cover body (210) and a peripheral edge (214) corresponding to the peripheral edge (140) of the board (100), enabling aligned engagement. In certain embodiments, the cover (200) may include a domed portion (212), as further illustrated in the figures, and a transparent region (216) to enhance visibility of food items positioned beneath the cover.

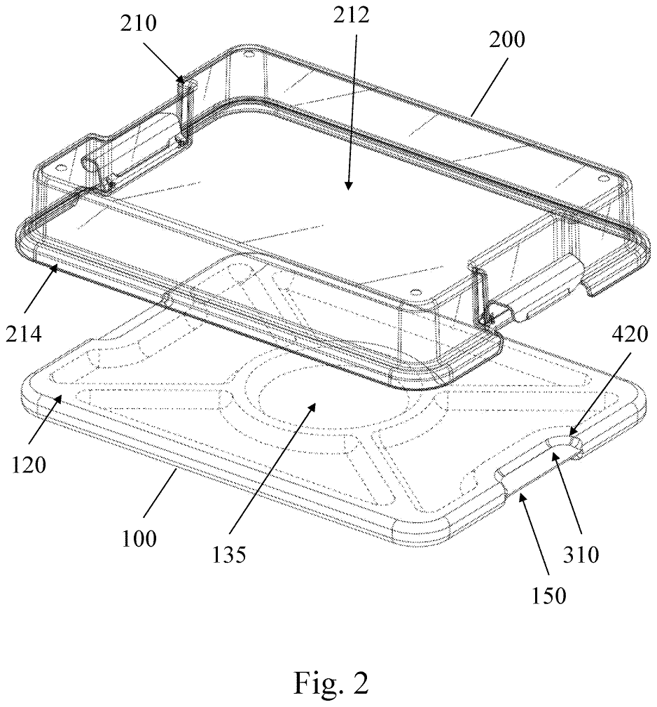

FIG. 2 provides an exploded view of its components, including the clasp mechanism (300) and the symmetrical attachment sections (400), showing how the cover (200), clasp mechanism (300), and board (100) are configured to be assembled. The exploded view further illustrates how the clasp mechanism (300) is associated with the cover (200) and positioned to engage the attachment sections (400) formed along the board (100).

FIGS. 3-6 illustrate the top and bottom surfaces (120, 122), which may include smooth, grooved, or divided sections (130) for different food arrangements. These figures demonstrate that the surfaces (120, 122) are independently usable and structurally configured to support food items.

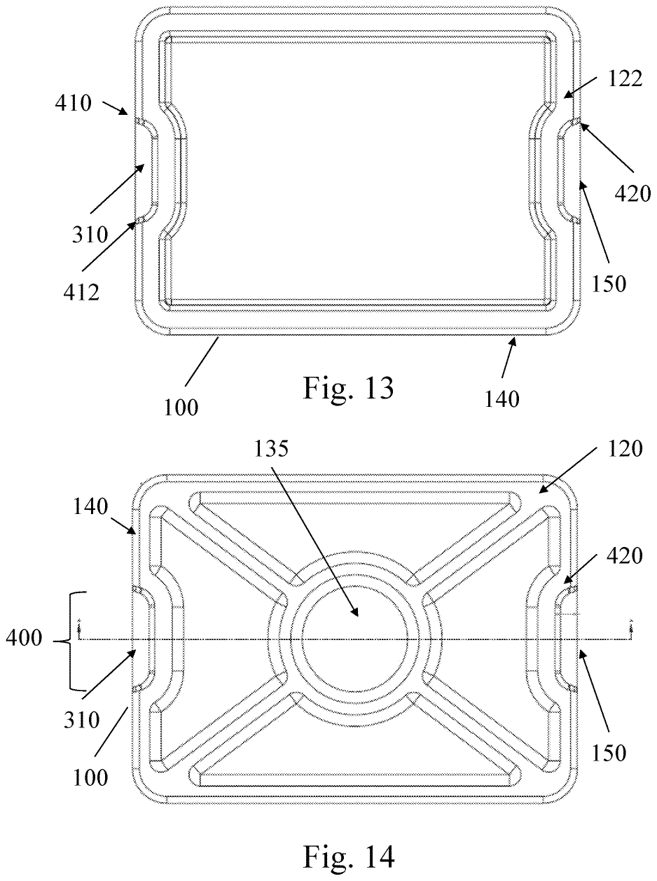

FIGS. 5-6 and 11-14 highlight two alternative surface designs for the charcuterie board (100). FIGS. 12 and 13 illustrate a flat surface, ideal for traditional food presentation. FIGS. 11 and 14 illustrate a divided section design, featuring compartments (130) for chips, nuts, or other food items, and a central circular recess (135) designed to hold a bowl for sauces, dips, or condiments. These figures demonstrate the versatility of the dual-surface configuration.

Now referring to FIG. 5-6, 15-16, and 19-25, the cover (200) and clasp attachment mechanism (300) are illustrated in detail. The cover (200) is secured to the board (100) via the clasp mechanism (300), which utilizes a compression fit and engages features along the peripheral edge (140).

FIG. 2 illustrates the side profile of the charcuterie board (100) with the cover (200) securely attached, demonstrating engagement between the clasp mechanism (300) and the board (100) along the peripheral edge (140), and alignment with the cover edge (214).

FIG. 4 provides a cross-sectional view, showing how the clasp mechanism (300) engages the board (100) using a compression fit, including an internal channel (322) that receives the peripheral edge (140) of the board (100). Portions of the clasp mechanism (300) may be deformable (324), allowing the mechanism to flex during engagement and return to a retaining position.

FIG. 15-18 provide an expanded view of the symmetrical attachment sections (400), showing recessed portions (310, 312) positioned along the board's edges, which serve as engagement points for the clasp mechanism (300). Protrusions (410, 412) extend outward, guiding the clasp mechanism (300) into position, and guide surfaces (420) further assist alignment during engagement. Compression-fit grooves (415) create resistance, securing the cover (200) in place. These figures illustrate that the attachment sections (400) are symmetrically arranged relative to both surfaces (120, 122).

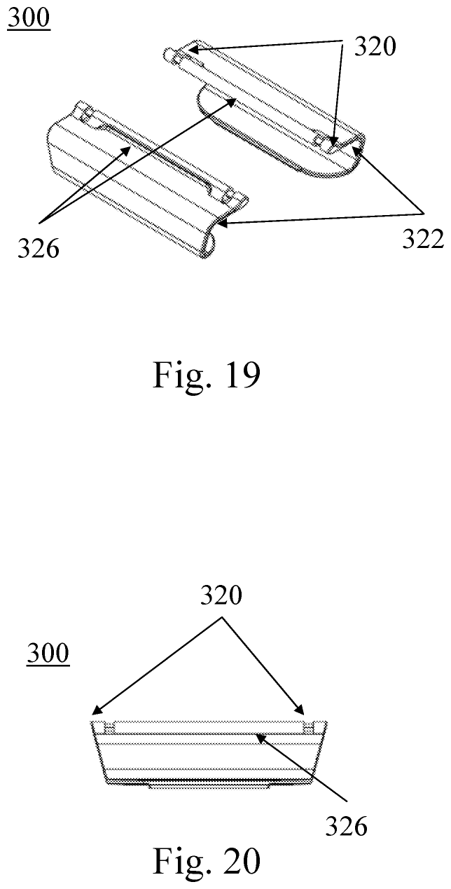

Now referring to FIG. 19-25, the clasp mechanism (300) is illustrated in detail. The clasp mechanism (300) may include engagement arms (320) configured to engage the recessed portions (310, 312). The clasp mechanism (300) may further include retention surfaces (326) that cooperate with the compression-fit grooves (415) to maintain a secure connection.

FIG. 4 shows the clasp mechanism (300) attached to the cover (200), in an open position, revealing its engagement arms (320).

FIG. 3 illustrates the clasp mechanism (300) partially engaged with the recessed attachment sections (310, 312) of the board (100), showing intermediate positioning during attachment.

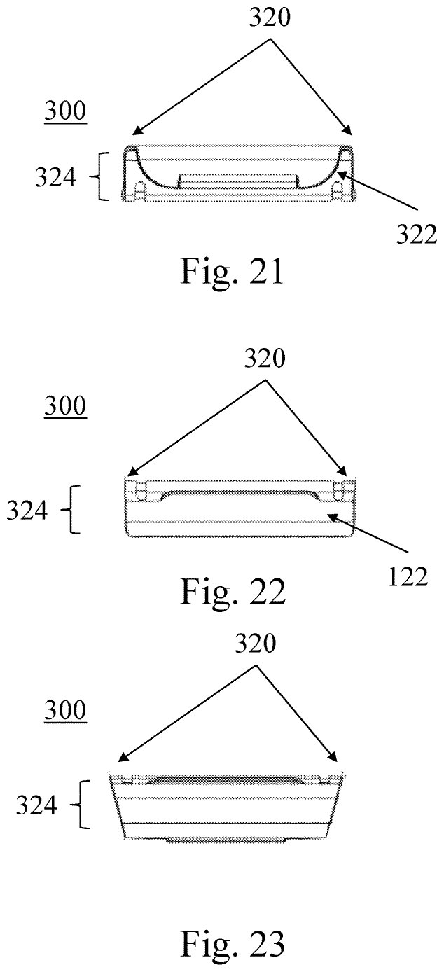

FIG. 21 presents a close-up view of the clasp mechanism (300), showing internal structural features including the internal channel (322) and deformable portion (324).

FIG. 22 provides a cross-sectional perspective, illustrating how the clasp mechanism (300) deforms under pressure before returning to its original shape to lock onto the board (100) securely.

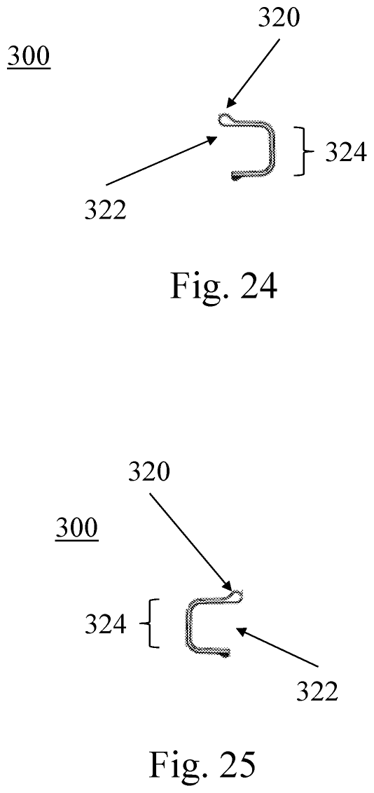

FIG. 23-24 show the engagement points within the attachment section (400), highlighting how the recessed portions (310, 312), protrusions (410, 412), and guide surfaces (420) align and guide the clasp mechanism (300) into proper engagement.

FIG. 25 illustrates how the symmetrical attachment points (400) allow the cover (200) to be attached regardless of which side of the board (100) is facing up, demonstrating the orientation-independent functionality.

In certain embodiments, the interface between the cover (200) and the board (100) defines a seal interface and may optionally include a gasket or sealing member to enhance sealing performance and reduce exposure to air.

Although the present invention has been described in considerable detail with reference to certain preferred embodiments, other versions are possible. Therefore, the point and scope of the appended claims should not be limited to the description of the preferred embodiments contained herein.

As for a further discussion of the manner of usage and operation of the present invention, the same should be apparent from the above description. Accordingly, no further discussion relating to the manner of usage and operation will be provided.

Therefore, the foregoing is considered as illustrative only of the principles of the invention. Further, since numerous modifications and changes will readily occur to those skilled in the art, it is not desired to limit the invention to the exact construction and operation shown and described.

Thus, it is appreciated that the optimum dimensional relationships for the parts of the invention, including variation in size, materials, shape, form, function, and manner of operation, assembly, and use, are deemed readily apparent.

Furthermore, other areas of art may benefit from this invention and adjustments to the design are anticipated. Thus, the scope of the invention should be determined by the appended claims and their legal equivalents.

1. An apparatus for supporting and selectively covering items, comprising:
a platform having a first surface and a second surface disposed on opposite sides of the platform, each of the first surface and the second surface being configured to support items;
a cover; and
a latch mechanism comprising at least one engagement element associated with the cover and at least one corresponding attachment region formed along a perimeter of the platform,
wherein the latch mechanism is configured to releasably secure the cover to the platform by engaging the attachment region, and
wherein the latch mechanism is further configured to secure the cover in a first configuration over the first surface and in a second configuration over the second surface without requiring reconfiguration of the latch mechanism.

2. The apparatus of claim 1,
wherein the attachment region comprises at least one recessed portion formed along an edge of the platform; and
wherein the attachment region is accessible from both the first surface and the second surface such that the latch mechanism engages identical or functionally equivalent attachment regions when securing the cover to either the first surface or the second surface.

3. The apparatus of claim 2, wherein the recessed portion is positioned such that the latch mechanism engages the attachment region in substantially the same manner when the platform is oriented with either the first surface or the second surface facing upward.

4. The apparatus of claim 1, wherein the engagement element comprises a deformable member configured to elastically engage the attachment region.

5. The apparatus of claim 4, wherein the deformable member is configured to generate a compression-based retention force.

6. The apparatus of claim 1, wherein the engagement interface comprises at least one of a snap-fit connection, a friction-fit connection, a magnetic coupling, or a compression-fit mechanism.

7. The apparatus of claim 1, wherein the attachment region further comprises a protruding guide surface configured to align the engagement element during attachment.

8. The apparatus of claim 1, wherein the engagement interface is configured to maintain a sealing engagement between the cover and the platform.

9. The apparatus of claim 1, wherein the first surface differs from the second surface in at least one of surface topology, compartmentalization, or functional geometry.

10. The apparatus of claim 9, wherein one of the first surface or the second surface includes a recessed region configured to receive a container.

11. A system comprising:
a reversible serving platform having opposing first and second serving surfaces;
a cover; and
a latch mechanism configured to releasably secure the cover to the platform,
wherein the latch mechanism includes complementary engagement structures formed on the platform and the cover, and
wherein the latch mechanism is operable to secure the cover to the platform in multiple orientations corresponding to the first and second serving surfaces without modification of the latch mechanism.

12. The system of claim 11, wherein the coupling mechanism comprises a plurality of engagement points distributed along a perimeter of the platform.

13. The system of claim 11, wherein the complementary engagement structures comprise at least one recessed portion and at least one corresponding engagement member configured to engage the recessed portion, and wherein the corresponding engagement member is configured to engage the recessed portion without requiring reorientation, repositioning, adjustment, or reconfiguration of the coupling mechanism between attachment to the first serving surface and attachment to the second serving surface.

14. The system of claim 11, wherein the coupling mechanism is configured to maintain attachment during transport of the platform.

15. The system of claim 11, wherein the cover comprises a domed configuration providing clearance for items positioned on the platform.

16. A method of covering items on a reversible platform, comprising:
placing items on a selected one of a first surface or a second surface of a platform;
positioning a cover adjacent the platform;
engaging a latch mechanism between the cover and the platform; and
securing the cover to the platform using the latch mechanism,
wherein the securing step is performed without requiring modification or reconfiguration of the latch mechanism based on which surface is selected.

17. The method of claim 16, further comprising reversing the platform and reattaching the cover to the platform using the same coupling mechanism.

18. The method of claim 16, wherein engaging the coupling mechanism comprises elastically deforming at least a portion of the coupling mechanism to create a compression fit.

19. The method of claim 16, wherein securing the cover comprises forming a sealing engagement between the cover and the platform.

20. The method of claim 16, further comprising transporting the platform while the cover remains secured.
